(19) United States
(12) Patent Application Publication
(10) Pub. No.: US 2002/0123309 A1
(43) Pub. Date: Sep. 5, 2002

(54) Communication system

(76) Inventors: James Digby Yarlet Collier, Cambridgeshire (GB); Philip Liam O'Donovan, Cambridge (GB)

Correspondence Address: ROTHWELL, FIGG, ERNST & MANBECK, P.C., 1425 K STREET, N.W., SUITE 800, WASHINGTON, DC, 20005, US

(21) Appl. No.: 10/073,069

(22) Filed: Feb. 12, 2002

(30) Foreign Application Priority Data
Feb. 21, 2001 (GB) 0104282.9

(51) Int. Cl. H04B 17/00

(52) U.S. Cl. 455/67.1; 455/67.3; 455/67.7

(57) ABSTRACT

A method and mobile terminal for providing a user with feed back indicative of link quality of a communication link between a first terminal used by the user and a second terminal. The method comprises the steps of introducing an audible queue, indicating a low link quality, into the audio signal heard by the user.

The present invention relates to a method and apparatus for indicating link quality in a communication link between two user terminals. In particular, but not exclusively, the invention relates to the provision of feedback for at least one user indicating the link quality.

In the past many different techniques have been used to provide a communication link between two or more users of a communication system. These communication links have themselves been used for many purposes including the support of voice calls between two or more users.

Digital encoding schemes are being increasingly used for voice communications as opposed to the analogue modulations such as direct frequency modulation of the audio signal.

While there are several reasons that digital schemes are superior, one characteristic of most digital schemes is that as the quality of the link degrades, due for instance to one mobile approaching an extreme range, the link quality holds up, only degrading very abruptly. Analogue schemes start to sound distorted or noisy well before coming unusable. This provides the users of such an analogue system with an indication that the link may be about to drop. This may enable the users to avoid such a break in communication by, for example, moving in the direction of a stronger signal. The suddenness of the onset of extreme degradation of the signal in digital schemes is increased by the use of error correction encoding (FEC) of the audio signals. In these even when the digital signal is decoded with some errors, the receiver can correct the bits in error. As a result a user may not notice any appreciable degradation in signal until a point at which the error correction can no longer operate. This point is likely to happen suddenly at a threshold value after which data integrity will be lost. Thereafter a call will be abruptly dropped.

This threshold effect has the undesirable effect that when the user of at least one end of a voice link is mobile he has no warning that he is moving from a region of good signal to poor until the link drops out altogether. Such a warning would be particularly useful when the user can actually do something about it. This is the case with cordless telephones, cordless headsets and other mobile telephones. It will be understood that by cordless is meant ranges of a few tens of meters where movements of a pace or even less can make some appreciable difference to signal strength. Analogue systems, because they start to sound noisy, do provide some warning.

It is an aim of embodiments of the present invention to at least partly mitigate the above-referenced problems.

According to a first aspect of the present invention there is provided a method for providing a user with feedback indicative of link quality of a communication link between a first terminal used by said user and a second terminal, said method comprising the steps of introducing an audible cue into the audio signal heard by said user said cue indicating a low link quality.

According to a second aspect of the present invention there is provided a mobile terminal comprising means for generating and introducing an audible cue into audio signals heard by a user of the mobile terminal when the link quality of a communication link between said mobile terminal and a second terminal is low.

According to a third aspect of the present invention there is provided a telecommunication system comprising a first and second terminal.

Preferably the audible cue comprises adding noise to the audio signal.

Conveniently the step of introducing an audible cue comprises reducing the volume of said audio signal.

Advantageously the method comprises the steps of responsive to a decrease in the link quality increasing a characteristic of said audible cue.

Preferably the method further comprises the steps of increasing the audible level of noise added to said audio signal as the link quality decreases.

Conveniently the method further comprising the steps of increasing the level of volume reduction as the link quality decreases.

Advantageously said first terminal is movable with respect to said second terminal.

The present invention is particularly suited to systems where one end of a communication link is fixed in position and the other is mobile. The receiver at each end monitors the signal quality, preferably by keeping an estimate of the bit error rate (which it can calculate if an FEC scheme is used) or by counting the rate at which packets are dropped (only in a radio standard that uses packets). Both of these are superior to merely measuring received signal strength (RSSI) although such a method or any other suitable method could be used.

Embodiments thus provide that the mobile end generates artificial noise and adds this to the audio signal output to the user in an amount that is a function of the signal quality. In this way the user or wearer is warned by means of an audible cue time to react that he is about to lose intelligibility. As an alternative embodiments decrease the volume of signal received by the mobile user who is pre-wamed that such an occurrence is indicative of a decrease in link quality.

Embodiments of the present invention will now be described hereinafter by way of example only with reference to the accompanying drawings in which:

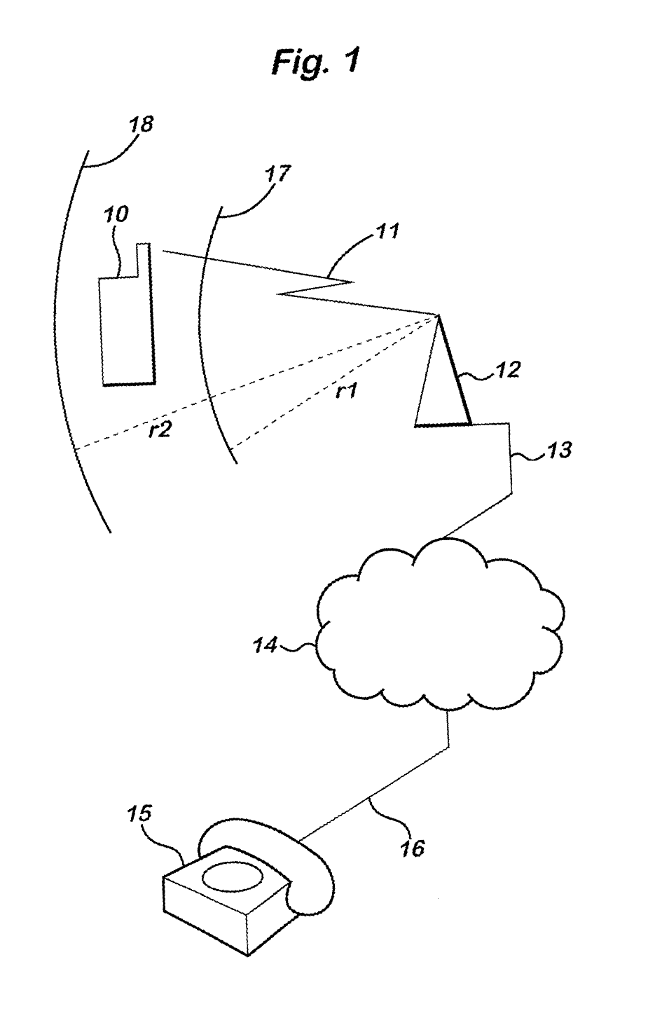

FIG. 1 illustrates how a mobile terminal can communicate with a second fixed terminal, and

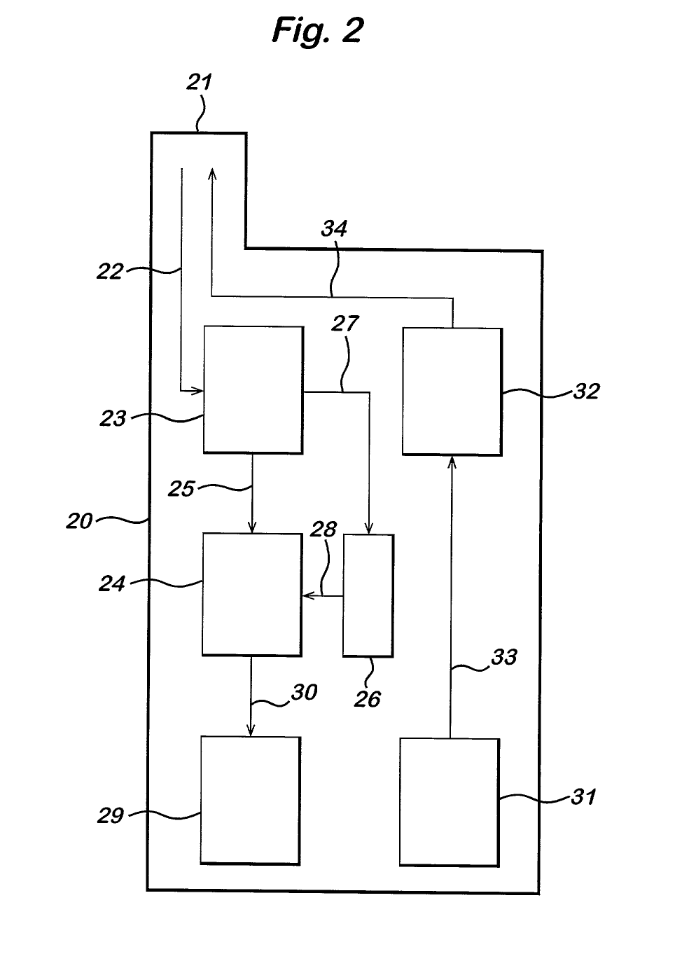

FIG. 2 illustrates portions of a mobile terminal.

In the description like reference numerals refer to like parts.

FIG. 1 illustrates how a mobile terminal 10 can communicate via a communication link 11 with a second terminal 12 which is fixed in position. It will be understood that whilst the following examples are described with respect to a first and second terminal being mobile and fixed respectively the invention is not so limited. It is only preferable that a first terminal is moveable with respect to the second terminal.

Likewise it would be understood that the phrase ‘terminal’ is used herein to cover any form of communication apparatus but is particularly useful in the context of either mobile telephones (or mobile stations) in a mobile telecommunication network or cordless telephones or headsets such as DECT (Digitally Enhanced Cordless Telephony) or Bluetooth phones.

For the purposes of illustration only the mobile terminal 10 in FIG. 1 can be considered as a cordless telephone whilst the fixed station 12 can be considered as its base station. This base station 12 is connected via hard link 13 (such as a wire) to a telecommunication network 14. Via this network 14 the mobile terminal user can communicate with a further user via a further terminal 15 which is connected to the network 14 via connection 16 which may also be a fixed line.

The base station 12 and mobile phone 10 communicates over the wireless communication link 11 which may be a radio link. The strength of this radio link will depend upon the distance between the base station and mobile phone. The link may also be affected by objects or sources of radio interference in the proximity of the communication link 11 although these effects are ignored for the purposes of the present illustration only. It will be understood that any detrimental effects on signal quality due to such objects can equally be overcome by the present invention in just the same way as distance effects are overcome as described hereinafter.

When a call is initiated between the user of the mobile terminal 10 and the user of the further terminal 15 a communication link is established. Thereafter the quality of signal received by both users is dependent upon the quality of this communication link. Since all connections other than the wireless link 11 are of a predetermined quality the quality of signal is highly dependent upon the wireless connection. By quality of signal is meant the quality of audio signal which is heard by each user. That is, how clearly a user can hear the voice of the other user when they speak. The audio signal will include speech patterns including formants etc together possibly with a little comfort noise as is known in the art. As the audio signal quality decreases more distortions of the voice patterns are detectable by the listener. These distortions are due in part to the loss of transmitted data which is equivalent to a reduction in data integrity. As data transmitted from the base station 12 is lost or spoilt it becomes more and more difficult for the audio signal, which is generated in the mobile terminal 10 or further terminal 15, to be correctly reconstructed.

The loss of data integrity will be particularly apparent when a user with the mobile terminal 10 moves away from the base station 12. In this circumstance the signal strength with which data is transmitted falls off (decreases) rapidly. In order to illustrate this two partial circles 17, 18 are shown in FIG. 1 having a radius r₁ and r ₂ respectively which are centered upon the base station 12. At distances less than r₁ from the base station signal strength is good and is sufficiently strong that substantially no loss of transmitted data occurs and thus no appreciable distortion occurs in the audio signal. At distances greater than r₂ from the base station the signal strength is so low that any communication link will be dropped because the loss of data integrity is two high to enable audio signals to be satisfactorily reconstructed at either the mobile or fixed or further terminals 10, 15.

As the mobile terminal moves within the zone defined between r_{1 and r}₂ the signal quality will be affected to some degree.

Without the present invention a user of the mobile phone 10 who moves, for example walks, away from the base station 12 would not notice a very appreciable difference in audio signal quality until a distance r₂ from the base station 12. This is because digital technology enables errors, due for example to lost data, to be corrected for and thus enables the audio signals corresponding to the other users voice to be reconstructed. However at a distance close to or at r₂ such error correction techniques are no longer adequate and effective. The result is that when a user operating mobile phone 10 moves past this point the call is dropped. The present invention overcomes this problem by providing an audible cue to at least one of the users, and preferably the user with the mobile phone, that the signal strength is weakening and thus that signal quality is decreasing. This audible cue can be in the form of introduced artificial noise, a reduction in volume or other change in volume, or a change in tone and may be preferably provided when the mobile user is in the region bounded by r₁ and r₂.

In response to this audible cue the user can move to a position of better signal strength (for example move nearer the base station 12) and thus obviate the disbenefit of the call being dropped.

Embodiments provide these audible cues to the user at the fixed terminal 15 who can then inform the mobile user of the audio signal degradation. However the audible cues is preferably provided in the mobile terminal 10 so that the mobile user, which is in a position to do something about the fact, can respond by moving to a position having a stronger signal strength. Alternative embodiments provide the audible cue to both the mobile and further terminals 15.

As noted above embodiments of the present invention provide this audible cue which is heard by a user by adding noise i.e. artificially generating background (or white) noise to the audio signal heard by the user. This has the result that as the user moves away from the base station 12 and passes the distance r, from the base station 12 a steady increase in noise occurs. This intuitively (and in analogy with analogue communication systems) informs the user that the signal strength is becoming worse as he moves in a certain direction. This suggests to the user that he may wish to move in a different direction to obtain a stronger signal.

There are various ways in which this artificial noise can be generated. This can be achieved by the analogue addition of noise or by spectrally shaping noise to have some psychological consequences. Alternatively either the mobile terminal 10 or further terminal 15 or fixed terminal 12 can include circuitry to generate noise such as using some form of look-up table or other parameterisable function. In essence only a source of random noise followed by a filter is necessary for example using a pseudo random number signal generator. Preferably these would be used to form a source of spectrally broadband noise.

As an alternative circuitry could be provided to control the volume of the audio signals heard by a user. Embodiments of the present invention include circuitry to either increase the volume or decrease the volume as the signal strength decreases. Provided a user is forewarned that such a volume effect is indicative of a decrease in signal strength. The reduction or increase in volume will be sufficient to act as an audible cue to the user that he should consider moving to a position of better signal strength.

Alternative embodiments provide this audible cue by varying the tone or some other audible aspect of the audio signal heard by a user. Again providing the user is forewarned that such an audible effect is indicative of a decrease in signal strength this will be sufficient to indicate the possibility of avoiding dropped calls.

FIG. 2 illustrates a mobile terminal 20 corresponding to the mobile terminal 10 of FIG. 1. The mobile terminal 20 includes an antenna 21 which is used to transmit and receive signals from the wireless communication link 11. Input signals are carried via connection 22 to decode circuitry 23 which decodes the transmitted data signals as is known in the art. These decoded signals are provided to an audio converter 24 via connection 25 and also to cue generating circuitry 26 via connection 27. The cue generating circuitry is responsive to these decoded signals and identifies whether the quality of the received signals is sufficiently high for adequate audio signals to be produced. That is, is the data integrity sufficiently good that the voice patterns of the user at the further terminal 15 will be sufficiently reproduced as to be intelligible by a user of the terminal 20. If the audible cue generating circuitry 26 generates an audible cue of the type noted hereinabove these signals will be provided to the audio converter 24 via connection 28. The audio converter 24 generates an audio pattern which is provided to an earpiece 29 via connection 30. A user of the mobile terminal 20 hears sounds corresponding to the voice patterns of a user of a terminal at the other end of the communication link via this earpiece. The mobile terminal 20 also includes a mouth piece 31 which is connected to circuitry 32 which is used to convert the voice patterns of the user of the terminal 20 into signals which can be transmitted via antenna 21 to a further user. The mouthpiece 31 is connected to circuitry 32 via connection 33 and circuitry 32 is connected to the antenna 21 via connection 34.

By generating an audible cue which a user of a terminal can hear and which highlights to a user that the signal strength of a communication link is low relative to a maximum link quality the user can be forewarned that a connection might be about to be dropped and can take some action accordingly. By low link quality is meant that the bit error ratio rises above some predetermined threshold, 0.1% for example, or that the packet drop rate rises above some other predetermined threshold. The result is that the audible cue generation can. for example begin as soon as link quality drops below 100% of the maximum link quality. Alternatively the audible cue is generated when link quality drops below 50% of maximum signal quality. Other embodiments can provide the audible cue at other points for example when signal quality is less than 10% of the maximum signal quality in the communication link. The measurement of the signals quality can be made in any appropriate way for example by keeping an estimate of the bit error rate or by counting the rate at which data packets transmitted over the communication link 11 are dropped or merely by measuring the received signal strength.

The fixed further terminal 15 can also signal to the mobile end its estimate of the quality of the signal that it is receiving. This signalling can be done in most systems via a data or control channel. This allows the mobile end to add noise also as a function of the signal quality not of its reception but of the fixed end reception. The desired impact of this is for the person that is mobile to move not only to ensure the quality of his reception but also to ensure the quality of signal received by his correspondent.

Embodiments of the invention introduce spectrally flat artificially generated noise as the audible cue however the noise need not be so constructed and can be chosen to have qualities that have a desired affect on the behavior of the user of the mobile terminal. It is preferable that the audible cue is not irritating or fatiguing in normal use.

Other alterations and modifications can be made to the above described examples without departing from the scope of the present invention as will be understood by those skilled in the art.

1. A method for providing a user with feedback indicative of link quality of a communication link between a first terminal used by said user and a second terminal, said method comprising the steps of:
introducing an audible cue into the audio signal heard by said user said cue indicating a low link quality.

2. The method as claimed in claim 1 wherein said step of introducing an audible cue comprises adding noise to said audio signal.

3. The method as claimed in claim 1 or 2 wherein said step of introducing an audible cue comprises reducing the volume of said audio signal.

4. The method as claimed in claim 1, 2 or 3 further comprising the steps of:
responsive to a decrease in the link quality increasing a characteristic of said audible cue.

5. The method as claimed in claim 4 further comprising the steps of:
increasing the audible level of noise added to said audio signal as the link quality decreases.

6. The method as claimed in claim 4 further comprising the steps of:
increasing the level of volume reduction as the link quality decreases.

7. The method as claimed in any one of claims 1 to 6 wherein said first terminal is movable with respect to said second terminal.

8. The method as claimed in any one of claims 1 to 7 wherein said first terminal comprises a mobile station.

9. The method as claimed in any one of claims 1 to 8 further comprising the steps of:
transmitting data from said second terminal to said first terminal over said communication link;
decoding said transmitted signal at said first terminal to form a decoded signal; and
at said first terminal converting said decoded signal into an audio signal which is audible by said user.

10. The method as claimed in claim 9 wherein said audio signal comprises sound representative of the speech pattern of a further user using said second terminal.

11. The method as claimed in any one of claims 1 to 10 further comprising the steps of:
introducing said audible cue when said link quality falls below a predetermined threshold value.

12. The method as claimed in claim 11 further comprising the steps of:
selecting the predetermined threshold value so that the audible cue is added to said audio signal prior to when said audio signal would otherwise be noticeably degraded due to decreasing link quality.

13. The method as claimed in any one of claims 1 to 12 further comprising the steps of:
controlling the volume of said audible cue so that the cue does not totally obscure said audio signal.

14. The method as claimed in any one of claims 1 to 13 further comprising the steps of:
adding the audible cue to indicate to a user of said first terminal that the communication link is likely to be terminated.

15. The method as claimed in any one of claims 1 to 14 further comprising the steps of:
only adding said audible cue to the audio signal heard by the user of said first terminal.

16. The method as claimed in claim 2 or any claim dependent thereon further comprising the steps of:
when said communication link includes digital encoding, adding noise to said audio signal by decreasing a performance characteristic of an error corrector in said first terminal.

17. The method as claimed in claim 2 or any claim dependent thereon further comprising the steps of:
adding noise to said audio signal by generating an artificial noise signal and adding this to the audio signal.

18. The method as claimed in claim 17 further comprising the steps of:
generating the artificial noise signal via a pseudo random number signal generator.

19. The method as claimed in claim 17 further comprising the steps of:
generating the artificial noise signal via a source of spectrally flat noise.

20. The method as claimed in claim 17 wherein said generated artificial noise signal comprises a spectrally shaped noise signal having psychological consequences.

21. The method as claimed in any one of claims 1 to 20 wherein said communication link comprises a wireless communication link.

22. The method as claimed in any one of claims 1 to 20 wherein said communication link comprises a digital communication link.

23. The method as claimed in any one of claims 1 to 22 wherein said first and second terminals are included in a telecommunication network.

24. The method as claimed in any one of claims 1 to 23 wherein said low link quality comprises a data transmission quality below 100% of a maximum signal quality.

25. The method as claimed in any one of claims 1 to 23 wherein said low link quality comprises a data transmission quality below 50% of a maximum signal quality.

26. The method as claimed in any one of claims 1 to 23 wherein said low link quality comprises a data transmission quality below 10% of a maximum signal quality.

27. The method as claimed in any preceding claim further comprising the steps of:
responsive to a variation in link quality varying at least one characteristic of said audible cue.

28. A mobile terminal comprising:
means for generating and introducing an audible cue into audio signals heard by a user of the mobile terminal when the link quality of a communication link between said mobile terminal and a second terminal is low.

29. A telecommunication system comprising a first and second terminal and arranged to carry out any one of the methods of claims 1 to 26.

30. A mobile terminal arranged to carry out the method of any one of claims 1 to 27.
